(19) United States
(12) Patent Application Publication
(10) Pub. No.: US 2007/0220600 A1
(43) Pub. Date: Sep. 20, 2007

(54) Response Delay Management Using Connection Information

(75) Inventors: Wilbert de Graaf, Bellevue, WA (US); Chandresh K. Jain, Sammamish, WA (US)

Correspondence Address: MICROSOFT CORPORATION, ONE MICROSOFT WAY, REDMOND, WA, 98052-6399, US

(73) Assignee: Mirosoft Corporation, Redmond, WA (US)

(21) Appl. No.: 11/276,932

(22) Filed: Mar. 17, 2006

(51) Int. Cl. G06F 12/14

(52) U.S. Cl. 726/22

(57) ABSTRACT

A computer implemented method comprising receiving a connection, determining a credit status of the source of the connection, setting a response delay time length corresponding to the credit status of the source, and waiting the response delay time length before sending a response. A hacker or malicious user using a source may make use of the fact a server application adds a delay to negative responses to equate a time delay with a negative response and therefore drop a connection upon discovering a time delay. A tarpitting component may discourage or defeat such hacker or malicious user behavior by storing the identity of the source and adding the delay to negative responsive to subsequent connections from the source.

### BACKGROUND

A server on a network such as the internet may typically accept connections and process commands from any source connected to the network. Most sources typically connect to the server for a legitimate purpose such as sending an electronic mail, requesting authentication, or requesting permission to use a resource. However, a hacker or malicious user may utilize a source on the network to connect to the server and discover information meant to be kept secret on the server such as an electronic mail address or a user identifier and corresponding password.

The hacker or malicious user may create a connection between the source and the server and make multiple attempts to authenticate using randomly generated or stored information to create a user identifier and corresponding password until a favorable response is returned from the server. The source may be capable of generating a large number of user identifiers and corresponding passwords in a short period of time. The source may typically submit the created user identifiers and created passwords to a server and the source may then check the response from the server to determine if the user identifier and/or password are valid. A server may typically discourage a hacker or malicious user by tarpitting, or delaying a response to the source of a connection by a certain amount of time.

### DESCRIPTION OF THE DRAWINGS

The present description will be better understood from the following detailed description read in light of the accompanying drawings, wherein:

FIG. 1 is a block diagram showing a conventional PC connected to a conventional Server computer by a network, the Server computer executing an operating system and a server application.

FIG. 2 is a block diagram showing a conventional PC connected to a Server computer by a network, the Server computer executing an operating system and a server application including a tarpitting component.

FIG. 3 is a flow diagram showing an example of a method for tarpitting a source of a connection.

FIG. 4 is a flow diagram showing an example method for responding to a command as part of the processing flow of FIG. 3.

FIG. 5 is a flow diagram showing an example method for closing a connection as part of part of the processing flow of FIG. 3.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a Server Personal Computer (PC) system, the system described is provided as an example and not a limitation. As those skilled in the art will appreciate, the present examples are suitable for application in a variety of different types of systems including a conventionally constructed Personal Computer (PC) intended for use in the home, Personal Digital Assistants (PDAs), portable telephones, consumer electronics devices including media players, virtualizations or emulations of Server computers or home PCs, and the like.

This description relates generally to a server application delaying or denying a response to the source of a connection in response to a determination that the source of a connection may be controlled by a hacker or malicious user. Typically, a hacker or malicious user may employ a variety of tactics to discover information meant to be kept secret on the server, for example, a user identifier and corresponding password or an electronic mail address. The hacker or malicious user may typically use the discovered information for a malicious purpose such as sending spam, or unsolicited electronic email, to the discovered electronic mail address or using the discovered user identifier and password to gain unauthorized access to the server application or other resources included on the server.

A hacker or malicious user may make use of a dictionary attack to discover information included in a server application. For example, the hacker or malicious user may typically use execute hacking software on a source, or computing device. The hacking software may take the form of a compiled executable application, a compiled component designed to add hacking functionality to non-hacking software, or a script designed to execute in a runtime environment.

Continuing the dictionary attack, the hacker or malicious user may typically direct the hacking software to connect to a server on the network which may be executing a server application. Once the hacking software has established a connection to the server application, the hacking software may typically generate at least one candidate user identifier and candidate password either at random or from a list of candidate user identifiers and candidate passwords. The hacking software may typically submit the candidate user identifier and candidate password to the server application such that the server application may process the authentication request. The hacking software may typically wait for a response from the server application. If the server responds positively, the hacker or malicious user may have discovered a valid user identifier and password. If the server responds negatively, the hacker or malicious user may direct the hacking software to repeat the dictionary attack until the hacker or malicious user is successful in discovering a user identifier and password.

In another example of a dictionary attack, a hacker or malicious user may execute hacking software on a source, or computing device. The hacker or malicious user may typically direct the hacking software to generate at least one candidate electronic email address. The hacking software may typically generate the at least one candidate electronic email address either at random or from a list of candidate electronic email addresses. The hacking software may typically connect to an electronic mail server application and create a command to send mail using the at least one candidate electronic email address. The hacking software may typically send the created command to the electronic mail server application such that the electronic mail server may process the created command and respond to hacking software executing on the source. If the electronic mail server application responds positively, the hacker or malicious user has discovered a valid electronic mail address and may then send unsolicited electronic mail, or spam, to the discovered valid electronic email address. If the electronic mail server application responds negatively, the hacker or malicious user may repeat the process until they have discovered any number of valid electronic mail addresses.

A hacker or malicious user may configure the hacking software such that the hacking software is typically able to establish many connections and make a large number of requests of a server application within a short period of time. However, a server application may typically defeat or discourage such hacking software by tarpitting, a process by which the server application typically adds a time delay to each negative response returned to the source of a connection. The server application may further increase the time delay in relation to the number of negative responses returned to the source of a connection. Such a time delay may reduce the number of requests hacking software may make of a server application and may therefore discourage or defeat a hacker or malicious user controlling the hacking software executing on a source of a connection.

However, the hacker or malicious user may further utilize knowledge that a positive response from a server application may be instantaneous and a negative response from a server application may be tarpitted, or delayed by some amount of time. That is, the hacker or malicious user may direct the hacking software to disconnect from the server application if the response takes longer than a certain amount of time. The hacker or malicious user may consider the delay as a failed attempt and may then direct the hacking software to establish a new connection to the server application. The malicious user may then establish a new connection and may continue the attack.

Once again, the server application may typically defeat or discourage hacking software which disconnects if the response takes a certain amount of time by including a delay of equal time for both positive and negative responses. However, including a delay for both positive and negative responses for the server application may make the server application slower and less responsive to all users including users connecting to the server application for a legitimate purpose.

A tarpitting software component which maintains a list of the address of sources and then delays negative responses sent to sources regardless of the connection status of the source may be useful. Such a tarpitting software component may also allow the server application to include no delay in positive responses. It may also be useful for the tarpitting software component to add credit status information to the entry in the list corresponding to the address of a source based on the behavior of the source.

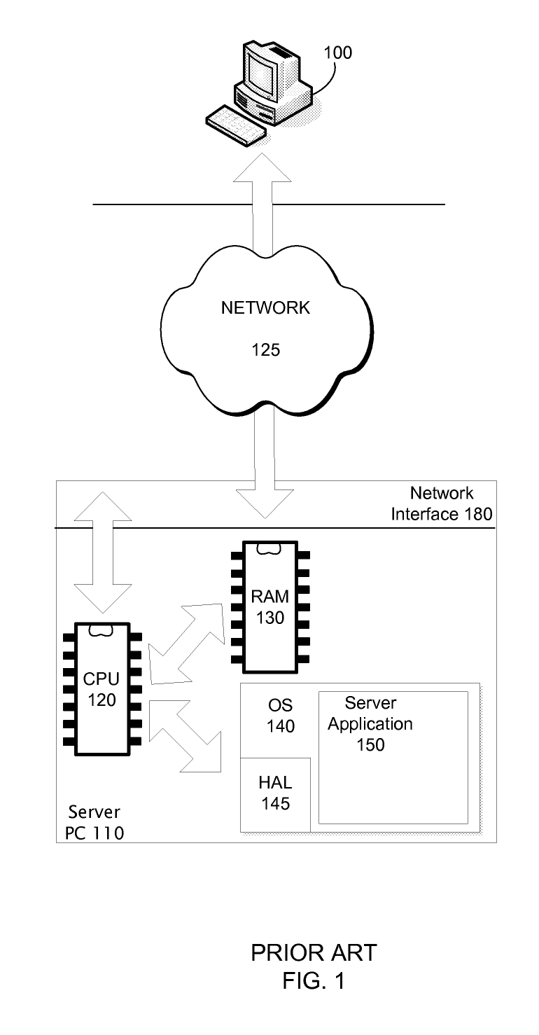

FIG. 1 is a block diagram showing a conventional Server computer 110 coupled to a network 125, such as the internet, and a conventional PC 100 also coupled to a network 125, such as the internet. The conventional Server computer 110 and the conventional PC 100 may communicate using a connection established over the network 125.

The conventional Server computer 110 may be a conventionally constructed server computer or its equivalent configured to connect to a network 125, such as the internet, and execute a conventional server application 150 which may respond to requests received over network 125 connections from sources, for example the conventional PC 100.

The conventional Server computer 115 may typically include a conventional central processing unit (CPU) 120, a conventional random access memory (RAM) 130, and a conventional network interface 180. The conventional network interface 180 may be a conventional network interface card (NIC) or the like connected to a Peripheral Component Interconnect (PCI) local bus, a Personal Computer Memory Card International Association (PCMCIA) slot, an Accelerated Graphics Port (AGP), or the like.

The conventional Server computer 110 may typically execute a conventional Operating System (OS) 140. The conventional OS 140 may provide a conventional hardware abstraction layer 145. The conventional hardware abstraction layer 145 may include an application programming interface (API) through which a conventional server application 150 may communicate with hardware devices such as the network interface 180. A conventional hardware abstraction layer 145 may provide developers of applications with a consistent API through which they may receive and send information from a variety of hardware devices such as a conventional network interface 180.

The conventional PC 100 may be any conventionally constructed personal computer or its equivalent constructed to be coupled to the network 125, establish a connection to the conventional Server computer 110 using the network 125, and communicate with the conventional Server computer 110. The conventional PC 100 may also include any communication protocols necessary to communicate with the conventional Server computer 110. For example, the conventional PC 100 may include the simple mail transfer protocol (SMTP) used to communicate with electronic mail servers.

The conventional PC 100 may further include functionality to create and/or compile applications, components, modules, scripts, or the like. The conventional PC 100 may also further include functionality to download scripts, source code, snippets of source, and the like from a source on the network 125. For example, the conventional PC 100 may include an integrated developer environment (IDE) such as Microsoft Visual Studio 2005 or Sun Microsystems Java Studio Creator. The IDE may function to create an application or module which may be coupled to a communication protocol such that the application or module is capable of executing commands on a conventional Server computer 110.

A user of the conventional PC 100 may make use of the functionality to create and/or compile applications, components, modules, scripts, or the like which utilize a communication protocol and may be able to send requests to the conventional server application 150 executing on the conventional server computer 110. If such a user is a hacker or malicious user, they may create an application, component, script, or the like which may attempt to discover information included with the conventional server application 150 which is intended to remain secret, for example, a user identifier and the password corresponding to the user identifier. The hacker or malicious user of conventional PC 100 may then use the discovered user identifier and corresponding password to access the conventional server application 150 and any resources controlled by the conventional server application 150.

For example, such an application, component, script, or the like may include a dictionary, or a list, of candidate user identifiers and corresponding passwords. In an alternative example, the application, component, script, or the like may include an algorithm designed to either generate candidate user identifiers and corresponding candidate passwords randomly or according to a prescribed method such as advancing one letter in a selected word alphabetically. The application, component, script, or the like may then utilize a communication protocol, such as TELNET or SMTP, to establish a connection to the conventional server application 150 executing on the conventional Server computer 110. Once the application, component, script, or the like has established a connection to the conventional server application 150, the application, component, script, or the like may begin issuing commands to the conventional server application 150 and examine the response to determine if it is positive or negative in nature. The application, component, script, or the like may then repeat the operation described above as quickly as is possible.

The conventional server application 150 may discourage or defeat the application, component, script, or the like used by a hacker or malicious user of the conventional PC 100 by including a delay before sending a negative response to a command. A hacker or malicious user may typically expect a majority of responses from the conventional server application 150 to be negative, and therefore, a delay included in each negative response may reduce the number of requests the application, component, script, or the like may make of conventional server application 150. Such a reduced number of requests may also reduce the number of chances the application, component, script, or the like used by the hacker or malicious user of the conventional PC 100 may have to guess a user identifier or password.

However, a hacker or a malicious user of the conventional PC 100 may recognize that the conventional server application 150 includes a time delay with each negative response but does not include a time delay with each positive response. The hacker or malicious user of the conventional PC 100 may then include functionality in their application, component, script, or the like to disconnect from the conventional server application 150 if the response takes a certain period of time.

The conventional server application 150 may then further include a delay with each positive response in order to defeat or discourage the application, component, script, or the like used by a hacker or malicious user of the conventional PC 100. However, including a delay with each positive response may have the effect of reducing performance of the server for legitimate users of the conventional server application 150. A method of including a delay with each negative response and no delay with each positive response which may continue to defeat or discourage a hacker or malicious user of the conventional PC 100 may be accomplished in various ways. One such way may be a tarpitting method.

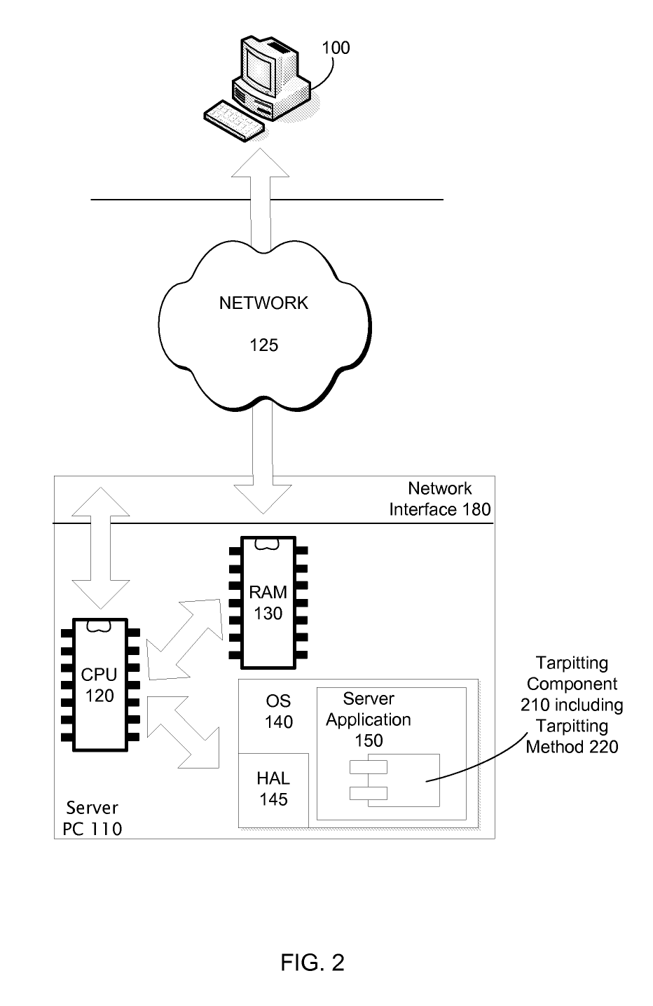

FIG. 2 is a block diagram showing a Server computer 110 executing an operating system 140, a server application 150, and a tarpitting component 210 for storing a list of sources which have connected to the server application 150 and either a list of time delay lengths or an algorithm to determine a time delay length. Such a tarpitting component 210 may implement a tarpitting method 220 in order to determine the length of a time delay to include before sending a response to the source of a connection, for example, the PC 100.

The components having like numbering from the previous figure function similarly, and the reader is directed to the previous figure for a description of their operation. A description of the new components is provided below.

The tarpitting component 210 may be an actual software component such as a component which conforms to the Microsoft Component Object Model (COM) standard or a component intended for use with a runtime environment such as Sun Java™ or the Microsoft .Net Frameworks. However, the tarpitting component 210 may also be a class or a member of class compiled in line with the computer code used to create the server application 150.

As previously discussed, a hacker or malicious user of the PC 100 may use an application, component, script, or the like to discover information included with the server application 150 which is intended to be kept secret, for example, a user identifier or a password associated with the user identifier. The tarpitting component 210 and the tarpitting method 220 implemented by the tarpitting component may defeat or discourage such an application, component, script, or the like used by a hacker or malicious user of the PC 100.

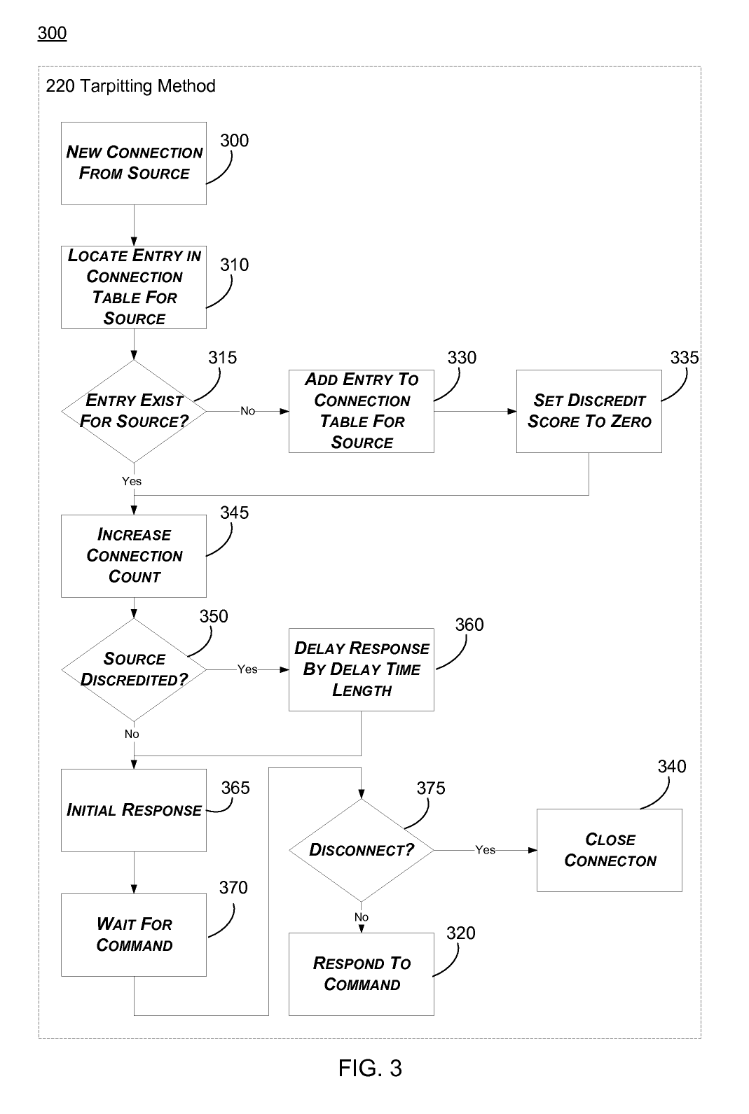

FIG. 3 is a flow diagram 300 showing an example tarpitting method 220 for defeating or discouraging a hacker or a malicious user of a source of a connection. As previously discussed, the tarpitting method 220 (from FIG. 2) may be implemented in a tarpitting component 210 (from FIG. 2). The tarpitting component is typically a software component or its equivalent, however, such a tarpitting method 220 may be equivalently implemented in any type of consumer electronics device which includes a processor and memory. If the tarpitting component 210 is executed in a PC environment with an operating system, the tarpitting component 210 typically implements a standard interface expected by the operating system. Such a standard interface may allow the operating system to expose the functionality and may allow reuse of the tarpitting component 210 to other components and applications which may execute in the operating system.

Block 300 may refer to an operation in which a connection request is received from a source. A source may typically be a personal computer (PC) connected to a network such as the internet; however, any typical computing device including functionality to establish a connection may be used.

The number of concurrent connections from a single source may be limited, and therefore new connections from a source may be denied if the source has exceeded the number of allowed connections. The total number of connections may also be restricted, and therefore a new connection from a source may be denied if the maximum number of concurrent connections has been reached. In addition, a connection may be refused if the source has already established a number of connections exceeding a percentage of the total number of connections or percentage of the total number of available connections.

Each time a connection is allowed, the address of the source may be stored in a connection table. For example, the internet protocol (IP) address of the source may be stored in the table. In an alternative example, the network path followed by the connection from the source may be stored in the table. In another alternative example, a domain representing one or more sources may be stored in the table.

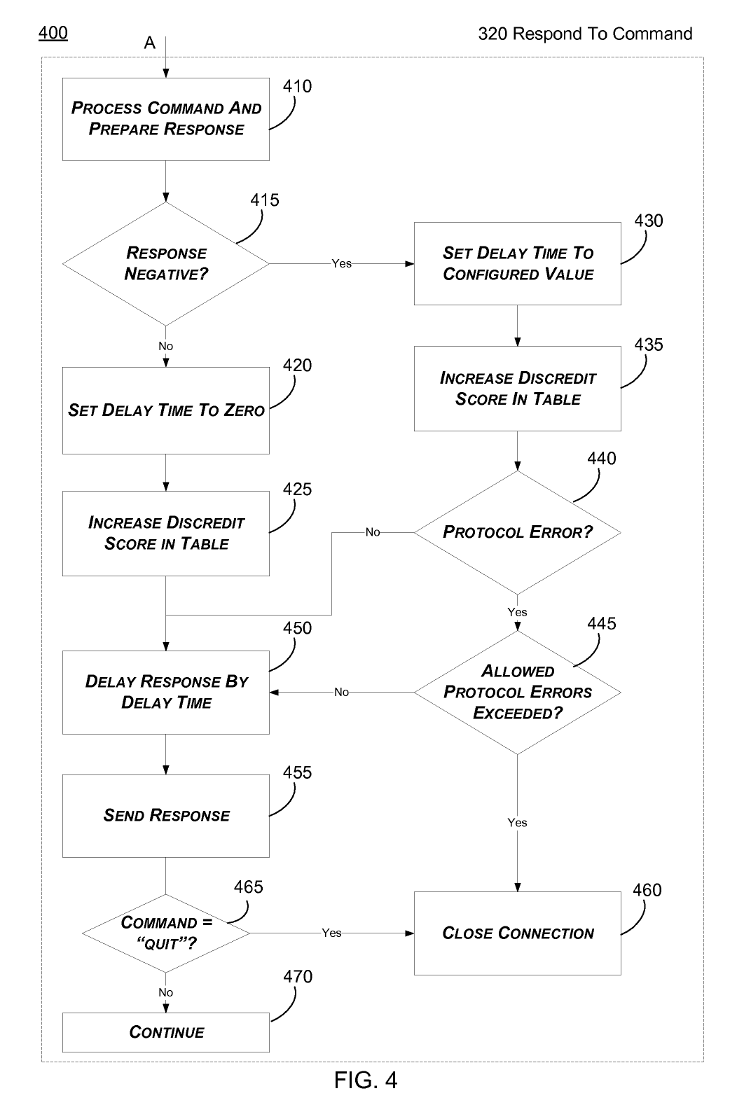

Additional information corresponding to the source may also be stored in the table. For example, information indicating credit status of the source may be stored in conjunction with the information identifying the source in the table. For example, an entry for a source in the table may include a value falling within a predetermined range. If the value is within a predetermined threshold, the source may be considered “discredited”. If the value is beyond a predetermined threshold, the source may considered to be “not discredited”. In an alternative example, an entry for a source in the table may include a boolean indicating the source is “discredited”. The entry for the source may also include a time stamp indicating when the connection with the source was established. The method by which credit status associated with a source may be set to “discredited” will be discussed further in the description of FIG. 4.

Block 310 may refer to an operation to locate an entry for the source in the connection table as discussed in the description of block 300. Flow continues on to block 315.

Block 315 may refer to a decision based upon the operation to locate an entry for the source in block 310. In response to a positive determination, flow continues to block 345. In response to a negative determination, flow continues to block 330.

Block 330 may refer to an operation in which the address of the source is added to the connection table. Flow continues to block 335.

Block 335 may refer to an operation in which the discredit score of the source is set to zero in the connection table. Flow continues to block 345.

Block 345 may refer to an operation in which a counter associated with the entry for the source in the connection table is incremented by a predetermined value. Flow continues on to block 350.

Block 350 may refer to a decision to determine if the credit status of the source is below an acceptable threshold value. The credit status of the source may have been stored in a connection table as discussed at block 300. The acceptable threshold value may be any predetermined value which represents a discredited status of a source. The method by which the credit status of a source may have been decreased to a level below an acceptable threshold will be discussed further in the description of FIG. 4. In response to a positive determination, flow continues on to block 360. In response to a negative determination, flow continues to block 365.

Block 360 may refer to an operation in which the response delay time is set to a preconfigured period of time. The length of the delay may be set to any length appropriate to discourage or defeat a hacker or malicious user of the source. In an alternative example, the length of the delay may be set in response to any factor related to the source of the connection and/or may be set according to a set schedule corresponding to the number of connections corresponding to the source. In another alternative example, the length of the delay may increase by a factor, either exponentially or logarithmically, corresponding to any factor related to the source of the connection. Flow continues to block 365.

Block 365 may refer to an operation in which a response is sent back to the source. Such a response may include a welcome message, a welcome banner, or the like. Flow continues on to block 370.

Block 370 may refer to an operation in which flow pauses until a command is received from the source. Once a command has been received from the source, flow continues on to block 375.

Block 330 may refer to a decision to determine if the command received from the source at block 370 was a command to drop the connection with the source. As discussed earlier, if a hacker or malicious user of the source is attempting to exploit the fact that a delay is added before a negative response and no delay is added before a positive response, the source may immediately disconnect if the source determines there is a delay in the response. In response to a positive determination, flow continues to block 340. In response to a negative determination, flow continues to block 320.

Block 320 may refer to an operation in which a response to the received command may be prepared. The process of preparing a response to the received command will be discussed more fully in the description of FIG. 4.

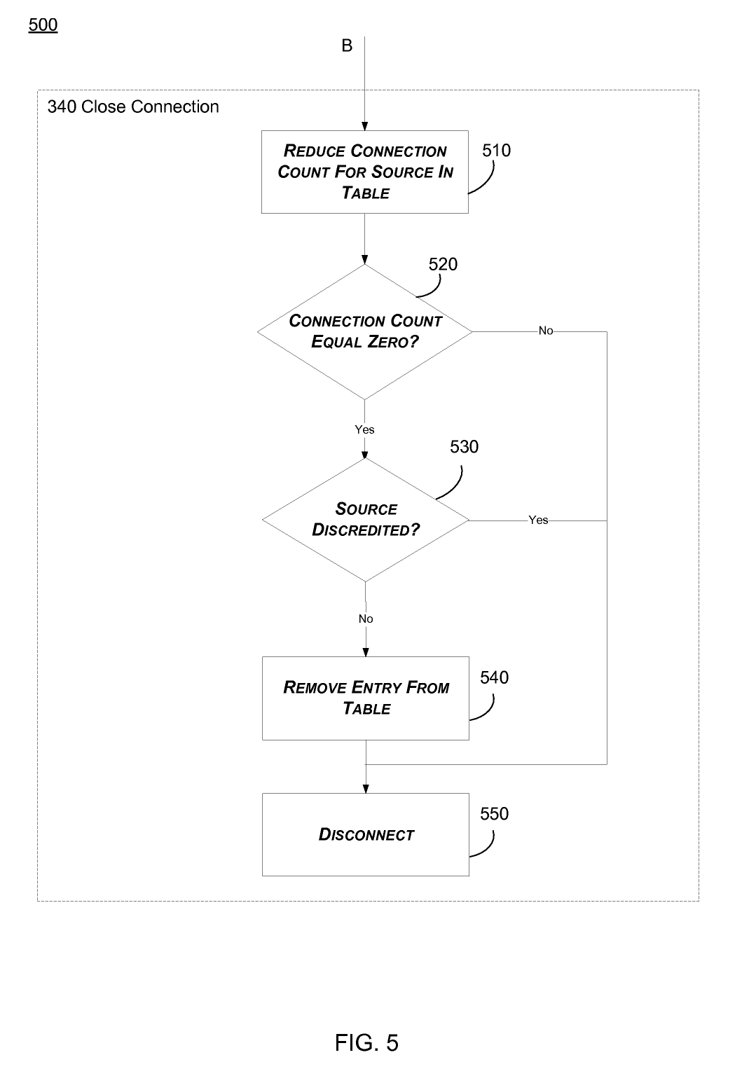

Block 340 may refer to an operation in which the connection with the source may be closed. The process of closing the connection with the source will be discussed more fully in the description of FIG. 5.

FIG. 4 is a flow diagram 400 showing an example method for responding to a command as part of the processing flow of FIG. 3.

Block 410 may refer to an operation in which the command received at block 310 of FIG. 3 is processed to create an appropriate response to the command which may then be sent to the source of the connection. Flow continues to block 415.

Block 415 may refer to a decision to determine if the response created at block 410 is a negative response. For example, if the command processed at block 410 is a simple mail transfer protocol (SMTP) command, the response to the SMTP command may be determined to be a 500-series response which may be further determined to be a negative response. In particular, any criteria relating to the behavior of a hacker or malicious user of a source of a connection may be used to determine whether the response created at block 410 is a negative response. In response to a positive determination, flow continues to block 430. In response to a negative determination, flow continues to block 420.

Block 430 may refer to an operation in which the response delay time is set to a preconfigured period of time. The length of the delay may be set to any length appropriate to discourage or defeat a hacker or malicious user of the source. In an alternative example, the length of the delay may be set in response to any factor related to the source of the connection and/or may be set according to a set schedule corresponding to the number of connections corresponding to the source. In another alternative example, the length of the delay may increase by a factor, either exponentially or logarithmically, corresponding to any factor related to the source of the connection. Flow continues to block 435.

Block 435 may refer to an operation in which the credit status of the source is increased. The credit status of the source may have been stored in a table as discussed at block 300 of FIG. 3. The credit status may be a value falling within a predetermined range of values, and the credit status of the source may be increased by adding a predetermined value to the current value stored in the table. Flow continues to block 440.

Block 440 may refer to a decision to determine if the response created at block 410 corresponds to a protocol error. That is, the response created at block 410 was created to inform the source of the connection that the command sent by the source of the connection resulted in an error. For example, if the command processed at block 410 is a simple mail transfer protocol (SMTP) command, the response to the SMTP may be determined to be a 500-series protocol error response. In response to a positive determination, flow continues to block 445. In response to a negative determination, flow continues to block 450.

Block 445 may refer to a decision to determine whether the number of protocol errors corresponding to the source of the connection has exceeded a predetermined maximum value. Such a predetermined value may be set to any value. For example, the predetermined maximum value may be set to a number corresponding to the behavior of a hacker or malicious user of a source of a connection. In response to a positive determination, flow continues to block 460. In response to a negative determination, flow continues to block 460.

Block 460 may refer to an operation in which the connection with the source of the connection is closed in response to a determination at block 445 that the source of the connection has exceeded the maximum number of allowed protocol errors.

Block 420 may refer to an operation in which the delay time is set to a length of zero. Flow continues to block 425.

Block 425 may refer to an operation in which the credit status of the source is increased. The credit status of the source may have been stored in a table as discussed at block 300 of FIG. 3. The credit status may be a value falling within a predetermined range of values, and the credit status of the source may be increased by adding a predetermined value to the current value stored in the table. Flow continues to block 450.

Block 450 may refer to an operation in which the response may be delayed for a length of time equal to the delay length set either at block 420 or block 430. Flow continues to block 455.

Block 455 may refer to an operation in which a response is sent to the source of the connection. Flow continues to block 465.

Block 465 may refer to a decision to determine if the command prepared at block 400 represented a command to quit processing. For example, if the command received at block 400 was a simple mail transfer protocol (SMTP) command, the SMTP command may have been a quit command. In response to a positive determination, flow continues to block 460. In response to a negative determination, flow continues to block

Block 470 may refer to operation in which the preparation of a response to the command received at block 400 may be continued.

FIG. 5 is a flow diagram 500 showing an example method for closing a connection as part of part of the processing flow of FIG. 3. Flow may have arrived at FIG. 5. in response to a positive determination that the source of the connection closed the connection at block 330 of FIG. 3.

Block 510 may refer to an operation in which the number of connections associated with the source in the table discussed at block 300 of FIG. 3 may be reduced by a predetermined value. For example, the connection count may be reduced by one if one connection was initiated by a source in FIG. 3. Flow continues to block 520.

Block 520 may refer to a decision to determine if the credit status of the source is set to “discredited” in the entry in the table discussed at block 300 of FIG. 3 corresponding to the source. In response to a positive determination, flow continues on to block 540. In response to a negative determination, flow continues on to block 550.

Block 530 may refer to a decision to determine if the credit status of the source is below an acceptable threshold value. The credit status of the source may have been stored in a table as discussed at block 300 of FIG. 3. The acceptable threshold value may be any predetermined value which represents a discredited status of a source. In response to a positive determination, flow continues on to block 550. In response to a negative determination, flow continues to block 540.

Block 540 may refer to an operation in which the entry corresponding to the source is removed from the table. More particularly, the source and a credit status corresponding to the source may have been added to a table as discussed at block 300 of FIG. 3. Flow continues to block 550.

Block 550 may refer to an operation in which the connection with the source is disconnected.

Methods and procedures for managing response delay times using connection information are disclosed. Those skilled in the art will realize that storage devices utilized to store program instructions can be distributed across a network. For example, a remote computer may store an example of the process described as software. A local or terminal computer may access the remote computer and download a part or all of the software to run the program.

Alternatively, the local computer may download pieces of the software as needed, or may distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A computer implemented method, comprising:
receiving a connection from a source;
determining a credit status of the source;
setting a response delay time length corresponding to the credit status;
waiting the response delay time length; and
sending a response to the source.

2. The computer implemented method of claim 1, further comprising adding the address of the source to a table.

3. The computer implemented method of claim 1, wherein the credit status is stored in an entry in a table corresponding to the source.

4. The computer implemented method of claim 1, further comprising receiving a command from the connection of the source.

5. The computer implemented method of claim 1, further comprising receiving a command from the connection of the source;
creating a negative response to the command; and
setting a response delay time corresponding to the negative response.

6. The computer implemented method of claim 1, further comprising determining the source has closed the connection.

7. The computer implemented method of claim 1, further comprising closing the connection to the source in response to determining the source has closed the connection.

8. The computer implemented method of claim 1, wherein the connection is a simple mail transfer protocol connection.

9. The computer implemented method of claim 1, further comprising setting the response delay time to zero in response to a determination that the credit status indicates the source is not discredited.

10. The system of claim 1, wherein the response delay time length is calculated based on at least one behavior of the source.

11. A computerized system, comprising:
a source of a connection connected to a network;
a server connected to the network, the server executing software to receive at least one connection from the source, the server further including a tarpitting component coupled to the software for determining a time delay length corresponding to a behavior of the source, the software waiting for a time period equal to the time delay length before sending a negative response to the source.

12. The computerized system of claim 11, wherein the source is a personal computer on the internet.

13. The computerized system of claim 11, wherein the source is identified by an internet protocol address.

14. The computerized system of claim 11, wherein the source is identified by a network path followed by the connection.

15. The computerized system of claim 11, wherein the source is identified by a second source acting as a proxy for the source.

16. The computerized system of claim 11, wherein the software is a simple mail transfer protocol software.

17. At least one computer-readable medium having one or more executable instructions that, when read, cause one or more processors to:
receive a first connection of a source;
determine the source has closed the first connection;
tarpit the source;
receive a second connection;
determine the first connection and second connection are from the same source; and
continue to tarpit the source.

18. The at least one computer-readable medium of claim 17, wherein the one or more instructions to determine the first and second connection are from the same source cause the one or more processors to compare the internet protocol address of the source of the first connection and the second connection.

19. The at least one computer-readable medium of claim 17, wherein the one or more instructions to tarpit the source cause the one or more processors to add a credit status to an entry in a table corresponding to the source.

20. The at least one computer-readable medium of claim 17, wherein the one or more instructions to continue to tarpit the source cause the one or more processors to increase the length of a predetermined period of time by a predetermined factor before sending a response to the source using the second connection.
